(19) United States
(12) Patent Application Publication
(10) Pub. No.: US 2026/0361917 A1
(43) Pub. Date: Nov. 12, 2026

(54) VIDEO ENCODING AND DECODING METHOD AND DEVICE OF PERFORMING FORMAT TRANSFORM PROCESSING

(71) Applicant: ATINS INC., Seongnam-si, Gyeonggi-do (KR)

(72) Inventors: Sun Young LEE, Seongnam-si, Gyeonggi-do (KR); Jae Bum JUN, Seongnam-si, Gyeonggi-do (KR); Pyoung Khang KIM, Seongnam-si, Gyeonggi-do (KR)

(21) Appl. No.: 19/486,851

(22) PCT Filed: Jun. 27, 2024
(86) PCT No.: PCT/KR2024/008939

§ 371 Date: Nov. 21, 2025

(30) Foreign Application Priority Data
Jun. 27, 2023 (KR) 10-2023-0082817

(51) Int. Cl. H04N 19/60; H04N 19/124; H04N 19/186; H04N 19/33

(52) U.S. Cl. CPC H04N 19/60; H04N 19/124; H04N 19/186; H04N 19/33

(57) ABSTRACT

The present disclosure relates to a video encoding and decoding method and device of performing format transform processing, and the encoding method may include receiving a video in an RGB format; transforming the received RGB format video into a video in an YCbCr format; encoding the transformed YCbCr format video; and transmitting transform information used to transform the RGB format video into the YCbCr format video together with the encoded YCbCr format video.

### TECHNICAL FIELD

The present disclosure relates to an encoding and decoding method capable of efficiently providing a cloud game service.

### BACKGROUND ART

As the cloud computing industry develops, the existing console game-oriented market structure is changing while incorporating cloud technology into the game market.

In the case of a general online game or mobile game, it is provided by installing a desired game on a user terminal to proceed with the game while minimizing connection to a server.

In contrast, in the case of a cloud game, all game-related information is stored on a cloud server, and provided as a service that immediately streams data to the user terminal.

That is, the cloud game is a game service that connects to a game server to proceed with a game and store items without installing the game on a terminal such as a smartphone, TV, computer, or tablet.

In this case, since the game server processes the main operations of the game, and the user terminal only shows a progress screen of the game, it is possible to enjoy a high-end game even on a low-spec terminal.

In order to provide such a cloud game service, the game server provides all services of a game requested by a user in a real-time video streaming method, and a game video, which is computer graphics processed data, has many differences from a live-action video captured by a camera, such as a change in pixel value.

Meanwhile, video compression methods used in the cloud game service include video compression standard technologies such as H.264/AVC, H.265/HEVC, VP8, VP9, and AV1, but those video compression standard technologies are developed to be suitable for a live-action video captured by a camera, and are not efficient for a game video generated through computer graphics processing.

In addition, unlike OTT services such as Netflix, which encodes content in advance and streams it in real time upon user request, the cloud game service receives feedback on a user action event and immediately reflects it in a game video to perform real-time video compression and streaming, and therefore, the complexity of video compression is a very important issue in the cloud game service.

### DISCLOSURE OF INVENTION

### Technical Problem

An aspect of the present disclosure is to provide a method and device for efficiently encoding and decoding a video through format transform processing.

### Technical Solution

A video encoding method according to one embodiment of the present disclosure may include receiving a video in an RGB format; transforming the received RGB format video into a video in an YCbCr format; encoding the transformed YCbCr format video; and transmitting transform information used to transform the RGB format video into the YCbCr format video together with the encoded YCbCr format video.

A video encoding device according to one embodiment of the present disclosure performs the foregoing video encoding method.

A video decoding method according to one embodiment of the present disclosure may include receiving a bitstream including information on a video in an encoded YCbCr format, and transform information used to transform a video in an RGB format into the YCbCr format video; decoding the encoded YCbCr format video; and transforming the decoded YCbCr format video into an RGB format video using the transform information.

A video decoding device according to one embodiment of the present disclosure performs the foregoing video decoding method.

Meanwhile, the transform information may include at least one of color specification information indicating a color space that can be expressed by the RGB format, color transformation information indicating a transform method used for color transformation from the RGB format to the YCbCr format, and transfer function information indicating a transfer function used for an optical-electrical transform for the RGB format video.

Meanwhile, at least some steps of the video encoding and decoding method may be implemented as a computer-readable recording medium in which a program for executing a computer is recorded, and may be provided as the program itself.

### Advantageous Effects

According to one embodiment of the present disclosure, transform information used to transform an RGB format video into a YCbCr format video may be transmitted to a decoder together with an encoded YCbCr format video, thereby allowing the color, or the like, of an original video to be expressed as it is in the decoder.

According to another embodiment of the present disclosure, when encoding a video generated by graphic processing, such as a game video, object location information or background transition information provided from a game server may be applied to block segmentation or coding mode determination, thereby reducing the operational complexity of the encoder.

### BRIEF DESCRIPTION OF THE DRAWINGS

FIG. 1 is a block diagram showing an overall configuration of a cloud game service system to which the present disclosure can be applied.

FIG. 2 is a flowchart showing a video encoding method according to one embodiment of the present disclosure.

FIG. 3 is a block diagram showing one embodiment of a configuration of a media server that performs a video encoding method.

FIG. 4 is a flowchart showing a video decoding method according to one embodiment of the present disclosure.

FIG. 5 is a block diagram showing one embodiment of a configuration of a user terminal that performs a video decoding method.

FIG. 6 is a block diagram for explaining a configuration and operation of a video encoder for encoding a video.

FIGS. 7 to 9 are drawings for explaining embodiments for a method of segmenting blocks of a video.

FIG. 10 is a block diagram for explaining a configuration and operation of a video decoder for decoding a video.

FIG. 11 is drawings for comparing and explaining the characteristics of a live-action video captured by a camera and a game video.

FIG. 12 is drawings for explaining the characteristics according to a motion of an object in a game video.

FIG. 13 is a flowchart showing a video encoding method according to another embodiment of the present disclosure.

FIGS. 14 to 17 are drawings for explaining embodiments of a method for determining block segmentation and coding mode according to object location information.

### BEST MODE FOR CARRYING OUT THE INVENTION

Hereinafter, a method and device of encoding and decoding a video according to an embodiment of the present disclosure will be described in detail with reference to the accompanying drawings.

In describing the present disclosure below, a detailed description of related known configurations or functions incorporated herein will be omitted when it is determined that the detailed description thereof may unnecessarily obscure the subject matter of the present disclosure. Furthermore, the terms described below are terms defined in consideration of the functions in the present disclosure, and may vary depending on the intention or custom of the user or operator. Therefore, the terms will be defined throughout the description of the present disclosure.

In addition, in order to efficiently describe technical elements constituting the present disclosure, according to preferred embodiments of the present disclosure to be implemented below, functional components that are already provided in each system or functional components that are commonly provided in the technical field to which the present disclosure belongs will be omitted as much as possible, and functional components that must be additionally provided for the present disclosure will be mainly described.

Anyone skilled in the art will easily understand the functions of elements that have been conventionally used among the functional components that are omitted and not shown below, and also clearly understand the relationship between the components that have been omitted as described above and the components added for the present disclosure.

In this specification, a device that encods a video to generate a video signal bitstream is referred to as an encoding device, an encoding device, or an encoder, and a device that decodes a video signal bitstream to restore a video is referred to as a decoding device, a decoding device, or a decoder.

A pixel or pel is a smallest unit that constitutes a video, and the terms pixel and sample may be used interchangeably. A sample may generally represent a pixel or a pixel value, or may represent only a pixel or pixel value of the luma component, or only a pixel or pixel value of the chroma component.

Additionally, a unit is used to refer to a basic unit of video processing or a specific location of a picture, and represents an image area including at least one of a luma component and a chroma component. Specifically, a unit may be used as a concept including all of a coding tree unit (CTU), a coding unit (CU), a prediction unit (PU), and a transform unit (TU). Furthermore, a block represents an image area including a specific component among luma components and chroma components, and an M×N block may represent a set of samples or transform coefficients consisting of M columns and N rows. Here, the terms unit, block, partition, signal and area may be used interchangeably.

Meanwhile, a picture refers to a field or a frame, and the terms may be used interchangeably. For example, when the video is an interlaced scanning video, one frame is divided into an odd (or odd, top) field and an even (or even, bottom) field, and each field consists of one picture unit to be encoded or decoded. Furthermore, when the video is a progressive scanning video, one frame consists of a picture to be encoded or decoded.

FIG. 1 is a block diagram showing an overall configuration of a cloud game service system to which the present disclosure can be applied, and a cloud game service may be provided through a game server 10, a media server 20, and a user terminal 30.

Referring to FIG. 1, the game server 10 may provide a game service requested by a user in the form of real-time video streaming, and to this end, transmit a game video generated through computer graphics processing to the media server 20.

The media server 20 may compress the game video received from the game server 10 to transmit it to the user terminal 30, and to this end, a video encoder for encoding the video may be included in the media server 20.

The user terminal 30 decodes and plays a game video streamed in real time from the game server 10 through the media server 20, and to this end, a video decoder for decoding the video may be included in the user terminal 30.

In addition, the user terminal 30 may transmit an input signal corresponding to a user action event to the game server 10 for feedback, and the game server 10 may generate a game video reflecting the corresponding feedback and stream it through the media server 20.

According to one embodiment of the present disclosure, a game video generated by the game server 10 may be a video in an RGB format, and in this case, the media server 20 may transform the red, green, blue (RGB) format video into a luminance, chroma blue, chroma red (YCbCr) format video, then encode the transformed video, and transmit the encoded video to the user terminal 30.

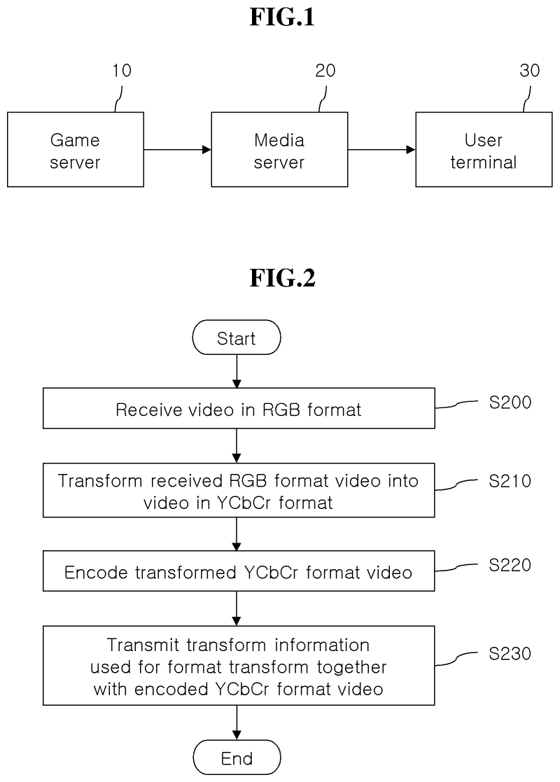

FIG. 2 is a flowchart showing a video encoding method according to one embodiment of the present disclosure.

Referring to FIG. 2, when a video in an RGB format is received (step S200), the received RGB format video is transformed into a video in a YCbCr format (step S210).

Then, the YCbCr format video transformed in step S210 is encoded (step S220), and transform information used to transform the RGB format video into the YCbCr format video in step S210 is transmitted together with the YCbCr format video encoded in step S220 (step S230).

Here, the transform information may include color specification information indicating a color space that can be expressed by the RGB format of the received video, and color transformation information indicating a transform method used for color transformation from the RGB format to the YCbCr format.

Additionally, in step S210, an optical-electro transform may be performed on the RGB format video, and in this case, transfer function information indicating a transfer function used in the optical-electro transform may be included in the transform information.

Therefore, the transform information transmitted together with the YCbCr format video encoded in step S230 may include color specification information, color transformation information, and transfer function information, but the present disclosure is not limited thereto, and may include various information items related to a format transform.

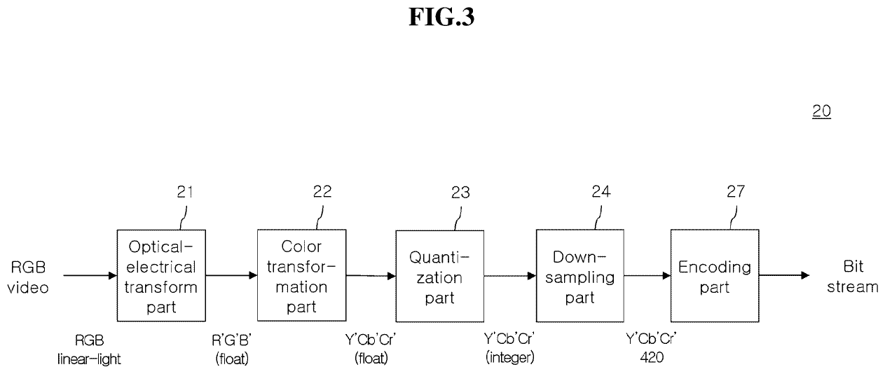

FIG. 3 is a block diagram showing one embodiment of a configuration of a media server that performs a video encoding method, and shows a configuration of the media server 20 for performing an encoding method as described with reference to FIG. 2.

Referring to FIG. 3, the media server 20 may include an optical-electrical transform part 21, a color transformation part 22, a quantization part 23, a down-sampling part 24, and an encoding part 27.

First, a game video received from the game server 10 to the media server 20 may be a video in an RGB format, and a color space that can be expressed by the corresponding RGB format may be determined by the color specification.

For example, the color specification of the RGB format may be BT.709-6, P3, BT.2020 or BT.2020-2, but the present disclosure is not limited thereto.

The optical-electric transform part 21 may perform an optical-electric transform on an RGB format video received from the game server 10 to transform an optical signal (RGB linear-light) into an electrical signal (R′G′B′(float)).

A transfer function used for the foregoing optical-electrical transform may be an optical-electrical transfer function (OETF) or an inverse function of an electro-optical transfer function (EOTF).

For example, the transfer function used for an optical-electrical transform may be in the form of an inverse HLG or inverse PQ, which is an inverse function of the electro-optical transfer function (EOTF), hybrid log-gamma (HLG), or perceptual quantizer (PQ), but the present disclosure is not limited thereto.

The color transformation part 22 may transform an RGB format video (R′G′B′(float)) output from the optical-electric transform part 21 into a YCbCr format video (Y′Cb′Cr′(float)).

A transform method of constant luminance (CL) or non-constant luminance (NCL) may be used for color transformation from an RGB format to a YCbCr format, but the present disclosure is not limited thereto.

When changing from the RGB format to the YCbCr format, in the case of constant luma (CL), a luma (Y) value is de-coupled from a chroma (Cb, Cr) value so as to be transformed, and in the case of non-constant luma (NCL), the luma (Y) value is completely de-coupled from the chroma (Cb, Cr) value so as not to be transformed.

Next, the quantization part 23 may perform quantization on the YCbCr format video (Y′Cb′Cr′(float)) transformed by the color transformation part 22 to output a YCbCr format video (Y′Cb′Cr′(integer)) having an integer value.

The down-sampling part 24 may perform chroma down-sampling on the video received from the quantization part 23 to change a YUV444 format to a YUV420 format, thereby outputting a YCbCr format video (Y′Cb′Cr′420).

Furthermore, the encoding part 27 may compress and encode the YCbCr format video (Y′Cb′Cr′420) received from the down-sampling part 24.

In order to encode a YCbCr format video, the encoding part 27 may use video codec standard technologies such as H.264/AVC, H.265/HEVC, H.266/VVC, VP8, VP9, AV1, and the like, but the present disclosure is not limited thereto.

The bitstream transmitted from the media server 20 to the user terminal 30 may include transform information used to transform an RGB format video into a YCbCr format video, together with a YCbCr format video encoded by the encoding part 27.

Here, the transform information may be included in the bitstream as a high-level syntax (HLS) in order to be used for video playback, and in this case, it may be inserted into at least one of video usability information (VUI), supplemental enhancement information (SEI), a video parameter set (VPS), a sequence parameter set (SPS), and a picture header (PH).

Furthermore, the transform information may include color specification information indicating a color space that can be expressed by an RGB format of the game video, color transformation information indicating a transform method used in the color transformation part 22 for a transform from the RGB format to a YCbCr format, transfer function information indicating a transfer function used in the optical-electrical transform part 21 for optical-electrical transform of the RGB format video, and the like.

Meanwhile, the game video may have different characteristics depending on a camera location (camera angle, point-of-view, or perspective), and the camera location may be divided into a first-person viewpoint, a third-person viewpoint, a top (top-down) viewpoint, a side viewpoint, a quarter (or isometric) viewpoint, and a shoulder (or back) viewpoint, depending on the viewpoint.

The characteristics of a video depending on the camera location may be as follows:
A first-person viewpoint constitutes a screen viewed by a camera from the first-person viewpoint, and has a better sense of realism and immersion than other viewpoints.
A third-person viewpoint may refer to a quarter or isometric viewpoint.
A top viewpoint is a viewpoint where the camera is attached to the ceiling to look down from the sky, in which the entire screen and the top of the head as a character are shown.
A side viewpoint is mainly used in 2D games, and is good to express the character's sense of action because the camera is on the side.
A quarter viewpoint is a viewpoint looking down from a diagonal line above the sky, with a good sense of space.
A shoulder viewpoint is a viewpoint where the camera is behind the character so as to provide a full view of the screen and the character.

Information such as a camera movement direction, a degree and angle of motion of a video, and a location and size of a background and object in the video may be inferred according to the camera viewpoint.

For example, in the case of a top viewpoint, there is one background, the background scrolls in a vertical direction, and small objects may exist on a large background screen. In the case of a side viewpoint, a movement of the left and right background screens is the main focus, and small objects may exist on a large background screen. In the case of a quarter viewpoint, there are more diagonal edges than horizontal and vertical edges due to a diagonal location of the camera, and small objects may exist on a large background screen.

Meanwhile, one or more camera viewpoints may be mixed, and for example, in the case of a back viewpoint, it may be mixed with the quarter viewpoint or the top viewpoint depending on the camera control. On the contrary, there are some viewpoints that cannot be mixed with one another, such as the top viewpoint and the quarter viewpoint.

As described above, the characteristics of a video may be different according to a camera viewpoint of the game video, and there may also be other differences in a method of switching a background screen or a method of operating an input device such as a mouse.

The foregoing camera viewpoint information may be included in the bitstream as a high-level syntax (HLS), and inserted into at least one of video usability information (VUI), supplemental enhancement information (SEI), a video parameter set (VPS), a sequence parameter set (SPS), a picture parameter set (PPS), and a picture header (PH).

In addition, when there is a separate flag to indicate that the corresponding content is gaming contents, camera viewpoint information may be added in the form of an index when the corresponding flag value is “on”. The corresponding flag indicating that it is gaming contents may also be included in the bitstream as an HLS, and inserted into at least one of VUI, SEI, VPS, SPS, PPS, and PH.

In the above, although the embodiments of the present disclosure have been described as an example in which the encoding method according to the present disclosure is performed in the media server 20, the present disclosure is not limited thereto, and at least some steps of the encoding method may be performed in a separate video processing device.

According to one embodiment of the present disclosure, an encoded YCbCr format video transmitted from the media server 20 may be decoded at the user terminal 30 and then transformed into an RGB format video to be played back, and the decoding method performed at the user terminal 30 may be a reverse process of the foregoing encoding method.

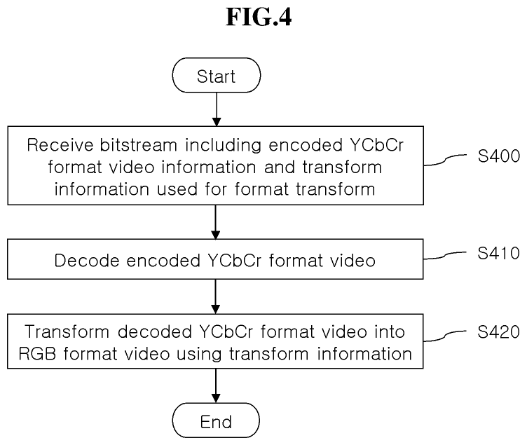

FIG. 4 is a flowchart showing a video decoding method according to one embodiment of the present disclosure.

Referring to FIG. 4, a bitstream including information on a video in an encoded YCbCr format and transform information used to transform a video in an RGB format into a YCbCr format video is received (step S400).

Next, encoded YCbCr format video is decoded using information parsed from the bitstream received in step S400 (step S410), and the decoded YCbCr format video is transformed into a video in an RGB format using the transform information (step S420).

Here, the transform information may include color specification information on an RGB format (e.g., an RGB format of a game video generated by the game server 10) and transform information on a color transformation method used in an encoding process (e.g., a color transformation process of the media server 20).

Additionally, in step S420, electro-optical transform may be performed on an RGB format video, and in this case, information on an optical-electrical transfer function used in the encoding process (e.g., the optical-electrical transform process of the media server 20) may be included in the transform information.

Therefore, the transform information included together with the YCbCr format video in the bitstream received in step S200 may include color specification information, color transformation information, and transfer function information, but the present disclosure is not limited thereto, and may include various information items related to a transform between the RGB format and the YCbCr format.

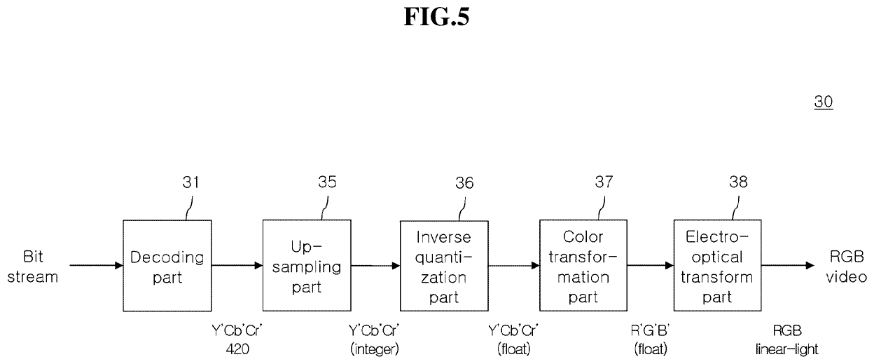

FIG. 5 is a block diagram showing one embodiment of a configuration of a user terminal that performs a video decoding method, and shows a configuration of the user terminal 30 for performing a decoding method as described with reference to FIG. 4.

Referring to FIG. 5, the user terminal 30 may include a decoding part 31, an up-sampling part 35, an inverse quantization part 36, a color transformation part 37, and an electro-optical transform part 38.

A bitstream received from the media server 20 to the user terminal 30 may include information on an encoded YCbCr format video and transform information used to transform an RGB format video into a YCbCr format video in the media server 20.

For example, the transform information may be included in at least one of video usability information (VUI), supplemental enhancement information (SEI), a video parameter set (VPS), a sequence parameter set (SPS), a picture parameter set (PPS), and a picture header (PH) as a high-level syntax (HLS) in the bitstream.

Furthermore, the transform information may include color specification information for an RGB format, color transformation information indicating a color transformation method, transform function information indicating a transfer function used for optical-electrical transform, and the like.

The decoding part 31 may decode an encoded YCbCr format video using information included in the bitstream.

In order to decode a YCbCr format video, the decoding part 31 may use video codec standard technologies such as H.264/AVC, H.265/HEVC, H.266/VVC, VP8, VP9, AV1, and the like, but the present disclosure is not limited thereto.

Meanwhile, the bitstream received from the media server 20 to the user terminal 30 may additionally include the foregoing camera viewpoint information, and accordingly, the decoding part 31 may decode a video using differences according to a camera viewpoint or use them as metadata after decoding.

The up-sampling part 35 performs chroma up-sampling on a decoded YCbCr format video (Y′Cb′Cr′420) output from the decoding part 31 to change a YUV420 format to a YUV444 format, thereby outputting a YCbCr format video (Y′Cb′Cr′(integer)).

Next, the inverse quantization part 36 may perform inverse quantization on the YCbCr format video (Y′Cb′Cr′(integer)) to output a YCbCr format video (Y′Cb′Cr′(float)) having a real value.

The color transformation part 37 may transform a YCbCr format video (Y′Cb′Cr′(float)) into an RGB format video (R′G'B′(float)).

Here, the color transformation part 37 may transform a YCbCr format video (Y′Cb′Cr′(float)) into an RGB format video (R′G′B′(float)) using the same color transformation method used in the media server 20, by using color transformation information among the transform information included in the bitstream.

For example, when constant luminance (CL) is used for color transformation in the media server 20, the color transformation part 37 may transform a YCbCr format video (Y′Cb′Cr′(float)) into an RGB format video (R′G′B′(float)) using the constant luminance (CL) method, and when non-constant luminance (NCL) is used, the color transformation part 37 may transform a YCbCr format video (Y′Cb′Cr′(float)) into an RGB format video (R′G′B′(float)) using the same non-constant luminance (NCL) method.

In addition, the color transformation part 37 may transform a video into an RGB format video (R′G′B′(float)) according to a specification having the same color space as the game video generated by the game server 10 by using the color specification information among the transform information included in the bitstream.

Accordingly, in the video played on the user terminal 30, the intended color may be expressed as it is when producing the game video.

For example, the color transformation part 37 may transform a YCbCr video into an RGB video according to the BT.709-6 specification when the RGB color specification of the game video generated from the game server 10 is BT.709-6, transform the YCbCr video into an RGB video according to the P3 specification when it is P3, transform the YCbCr video into an RGB video according to the BT.2020 specification when it is BT.2020, and transform the YCbCr video into an RGB format video according to the BT.2020-2 specification when it is BT.2020-2.

Furthermore, the electro-optical transform part 38 may perform an electro-optical transform on the RGB format video (R′G′B′(float)) output from the color transformation part 37, thereby transforming the electrical signal (R′G′B′(float)) into an optical signal (RGB linear-light).

Here, the electro-optical transform part 38 may apply an inverse function (inverse OETF or EOTF) corresponding to a transfer function used in the media server 20 using transfer function information among the transform information included in the bitstream to output an RGB format video (RGB linear-light) transformed into an optical signal.

For example, the electro-optical transform part 38 may transform, when an inverse HLG transfer function is used for the optical-electrical transform in the media server 20, an electrical signal (R′G′B′(float)) into an optical signal (RGB linear-light) using an HLG transfer function, and transform, when an inverse PQ transfer function is used, an electrical signal (R′G′B′(float)) into an optical signal (RGB linear-light) using a PQ transfer function.

Meanwhile, the foregoing transform process may be performed by linking transform information and bit-depth information per pixel.

For example, the electro-optical transform part 38 may perform an electro-optical transform using at least one of color specification information, color transformation information, and bit depth information in addition to transfer function information.

In addition, the color transformation part 37 may perform color transformation using at least one of transfer function information, color specification information, and bit depth information in addition to color transformation information.

A video in an RGB format output from the electro-optical transform part 38 may be played through a display of the user terminal 30.

As described above, as the transform information used to transform an RGB format video into a YCbCr format video in the media server 20 is transmitted to the user terminal 30 via a bitstream, the video played in the user terminal 30 may be restored to have characteristics such as color as much as possible similar to the game image generated by the game server 10.

In the above, although the embodiments of the present disclosure have been described as an example in which the decoding method according to the present disclosure is performed in the user terminal 30, the present disclosure is not limited thereto, and at least some steps of the decoding method may be performed in a separate video processing device.

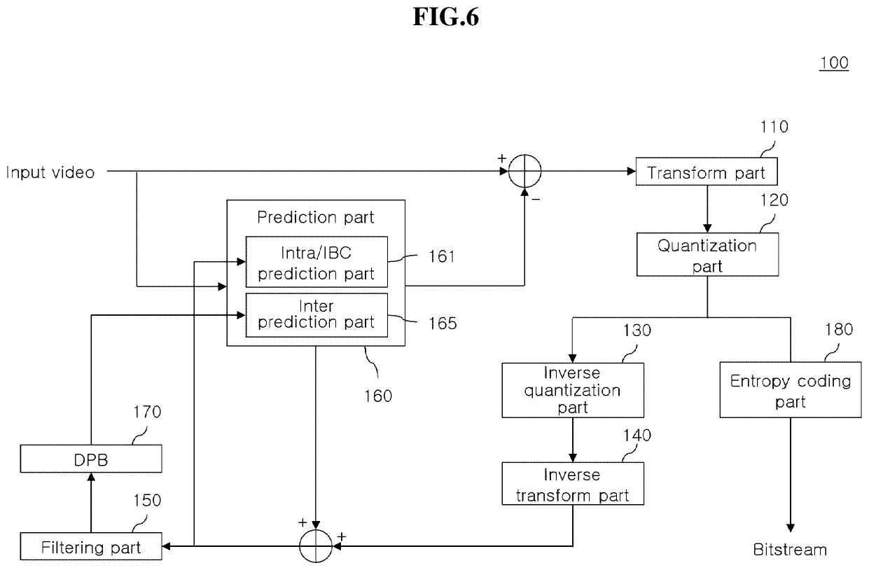

Hereinafter, embodiments of encoding and decoding methods and devices applicable to the present disclosure will be described with reference to FIGS. 6 to 10.

FIG. 6 shows a diagram for explaining a configuration and operation of a video encoder for encoding a video, and the shown video encoder 100 may be configured to include a transform part 110, a quantization part 120, an inverse quantization part 130, an inverse transform part 140, a filtering part 150, a prediction part 160, a decoded picture buffer (DPB) 170, and an entropy coding part 180.

Referring to FIG. 6, the transform part 110 transforms a residual signal, which is a difference between an input video signal and a prediction signal generated by the prediction part 160, to acquire a transform coefficient value.

For example, a discrete cosine transform (DCT), a discrete sine transform (DST), or a wavelet transform may be used.

A transform kernel used for a transform on a residual block may be a transform kernel having separable characteristics of a vertical transform and a horizontal transform. In this case, the transform for the residual block may be performed separately into a vertical transform and a horizontal transform. For example, the encoder may perform a vertical transform by applying a transform kernel in a vertical direction of the residual block. In addition, the encoder may perform a horizontal transform by applying a transform kernel in a horizontal direction of the residual block.

Meanwhile, the transform kernel may be used as a term referring to a set of parameters used for transforming the residual signal, such as a transform matrix, a transform array, a transform function, or a transform, and may be any one of a plurality of available kernels, and transform kernels based on different transform types may be used for each of the vertical transform and the horizontal transform.

The transform coefficients may be distributed such that higher coefficients are distributed toward an upper left of the block, and coefficients closer to ‘0’ are distributed toward a lower right of the block. Additionally, as a size of the current block increases, there is a possibility that there will be a lot of coefficients of ‘0’ in a lower right area, and in order to reduce the transform complexity of a large block, only an arbitrary upper left area may be left and the remaining area may be reset to ‘0’.

Additionally, error signals may exist only in some areas in a coding block, and in this case, the transform process may be performed only for some arbitrary areas. For example, in a block having a size of 2N×2N, an error signal may exist only in a first 2 N×N block, and in this case, the transform process may be performed only on the first 2N×N block, but the second 2N×N block may not be encoded or decoded withing performing the transform process.

The encoder may perform an additional transform prior to quantizing the transform coefficient. The foregoing transform method may be referred to as a primary transform, and the additional transform may be referred to as a secondary transform.

The secondary transform may be optional for each residual block, for example, the encoder may perform the secondary transform for an area where it is difficult to concentrate energy in a low-frequency area using only the primary transform to improve coding efficiency.

Specifically, the secondary transform may be additionally performed on blocks in which residual values appear significantly in directions other than a horizontal or vertical direction of the residual block, and the secondary transform may not be performed separately into a vertical transform and a horizontal transform, unlike the primary transform. The foregoing second-order transform may be referred to as a low frequency non-separable transform (LFNST).

The quantization part 120 quantizes a transform coefficient value output from the transform part 110.

In order to increase coding efficiency, instead of coding a picture signal as it is, a method of predicting a picture using an area already coded through the prediction part 160, and acquiring a restored picture by adding a residual value between the original picture and the prediction picture to the predicted picture is used.

In order to avoid mismatches between the encoder and decoder, when performing prediction in the encoder, information available in the decoder must also be used, and to this end, the encoder may perform a process of restoring the encoded current block again.

The inverse quantization part 130 inverse quantizes the transform coefficient value, and the inverse transform part 140 restores a residual value using the inverse quantized transform coefficient value.

The filtering part 150 performs filtering operations using a deblocking filter, a sample adaptive offset (SAO), an adaptive loop filter (ALF), and the like, to improve the quality of the restored picture and enhance encoding efficiency.

The deblocking filter is a filter for removing distortion within a block generated at a boundary between blocks in the restored picture, in which the encoder may determine whether to apply the deblocking filter to the corresponding boundary based on a distribution of pixels included in several columns or rows with respect to an arbitrary boundary within a block.

When the deblocking filter is applied, the filtering part 150 may apply a long filter, a strong filter, or a weak filter depending on a deblocking filtering strength, and may process horizontal filtering and vertical filtering in parallel.

The sample adaptive offset (SAO) may be used to correct an offset from the original video on a pixel-by-pixel basis for the residual block to which the deblocking filter is applied. The filtering part 150 may use a method of dividing pixels included in a video into a predetermined number of areas to correct an offset for a specific picture, then determining an area to perform offset correction, and applying the offset to the corresponding area (Band Offset). Additionally, the filtering part 150 may use a method of applying an offset in consideration of the edge information of each pixel (Edge Offset).

The adaptive loop filter (ALF) is a method of dividing pixels included in a video into predetermined groups, then determining one filter to be applied to the corresponding group, and performing filtering differentially for each group. Information regarding whether to apply an adaptive loop filter may be signaled on a coding unit basis, and the shape and filter coefficient of the ALF filter to be applied may vary according to each block. In addition, the same form of adaptive loop filter may be applied regardless of the characteristics of a target block to be applied.

The filtered picture may be stored in the DPB 170 to be used as a reference picture.

The prediction part 160 includes an intra/IBC prediction part 161 and an inter prediction part 165, in which the intra/IBC prediction part 161 performs intra prediction and IBC prediction within a current picture, and the inter prediction part 165 performs inter prediction to predict a current picture using the reference picture stored in the DPB 170.

The intra/IBC prediction part 161 performs intra prediction from restored areas within the current picture to transfer intra coding information to the entropy coding part 180. Here, the intra coding information may include at least one of an intra prediction mode, a most probable mode (MPM) flag, an MPM index, and information on a reference sample.

Additionally, the intra/IBC prediction part 161 may perform intra block copy (IBC) prediction from restored samples within the current picture to transmit IBC coding information to the entropy coding part 180.

In this case, the intra/IBC prediction part 161 may acquire a block vector value indicating a reference area used for prediction of a current area by referring to a specific area within the current picture, and perform IBC prediction using the acquired block vector value.

The intra/IBC prediction part 161 may transmit IBC coding information including at least one of size information of the reference area and block vector information (index information for block vector prediction of the current block within a motion candidate list, block vector difference information) to the entropy coding part 160.

The inter prediction part 165 finds a portion most similar to the current area by referring to a specific area of the restored reference picture, acquires a motion vector value that is a distance between the areas, and transmits motion information (reference direction indication information (L0 prediction, L1 prediction, bidirectional prediction), reference picture index, motion vector information, etc.) for the acquired reference area to the entropy coding part 180.

In addition, the inter prediction part 165 performs motion compensation using motion information to generate a prediction block for the current block, and transmits inter coding information including motion information for the reference area to the entropy coding part 180.

Meanwhile, the quantized transform coefficients in the form of a two-dimensional array may be rearranged into a one-dimensional array for entropy coding.

A method of scanning the quantized transform coefficients may be determined according to a size of the transform block and a prediction mode within the screen, and diagonal, vertical, and horizontal scans may be applied, and the scan information may be signaled on a block-by-block basis or derived from the decoder according to a set rule.

The entropy coding part 180 generates a bitstream by entropy coding information indicating quantized transform coefficients, intra coding information, and inter coding information, and to this end, a variable length coding (VLC) method and an arithmetic coding method may be used.

The variable length coding (VLC) transforms input symbols into a sequence of codewords, in which lengths of the codewords may be variable. For example, frequently occurring symbols may be represented with short codewords, and infrequently occurring symbols may be represented with long codewords.

As a variable length coding method, a context-based adaptive variable length coding (CAVLC) method may be used.

Arithmetic coding transforms consecutive data symbols into a single prime number using the probability distribution of each data symbol, thereby obtaining optimal prime number bits required to express each symbol.

As an arithmetic coding method, a context-based adaptive binary arithmetic code (CABAC) method may be used.

The CABAC is a method of binary arithmetic encoding through multiple context models generated based on probabilities obtained through experiments. The context model may also be called a context model. First, when the symbols are not in a binary form, the encoder binarizes each symbol using exp-Golomb, or the like. The binarized 0 or 1 may be described as a bin.

A CABAC initialization process is divided into context initialization and arithmetic coding initialization. The context initialization, which is a process of initializing the occurrence probability of each symbol, is determined by a type of symbol, a quantization parameter (QP), and a slice type (I, P, B). The context model having initialization information may use probability-based values obtained through experiments.

The context model provides the probability of occurrence of a least probable symbol (LPS) or most probable symbol (MPS) for a symbol currently being coded, and information (valMPS) on which empty value between 0 and 1 corresponds to the MPS.

One of multiple context models may be selected through a context index (ctxIdx), and the context index may be derived through information of a block currently to be encoded or information of neighboring blocks.

Initialization for binary arithmetic coding is performed based on a probability model selected from the context model. Binary arithmetic encoding proceeds with encoding through a process of segmenting the data into probability intervals based on the occurrence probabilities of 0 and 1, and then allowing a probability interval corresponding to a bin to be processed to be an entire probability interval for a bin to be processed next.

The location information within the probability interval where the last bin has been processed is output. However, since the probability interval cannot be segmented infinitely, when it is reduced to a predetermined size, a renormalization process is performed to expand the probability interval and output the corresponding location information. Additionally, subsequent to processing each bin, a probability update process may be performed in which a probability for a bin to be processed next is newly set through information on the processed bin.

As described above, the generated bitstream is encapsulated into network abstraction layer (NAL) units as basic units.

The NAL units may be divided into video coding layer (VCL) NAL units including video data and non-VCL NAL units including parameter information for decoding the video data, and there may be various types of VCL or non-VCL NAL units.

A NAL unit consists of NAL header information and data called a raw byte sequence payload (RBSP), and the NAL header information includes summary information on the RBSP. The RBSP of a VCL NAL unit includes an integer number of encoded coding tree units.

In order to decode a bitstream in the decoder, the bitstream must first be separated into NAL units, and then each separated NAL unit must be decoded. Meanwhile, information items required for decoding a bitstream may be transmitted as being included in a picture parameter set (PPS), a sequence parameter set (SPS), a video parameter set (VPS), or the like.

Meanwhile, the configuration and operation of the encoder described with reference to FIG. 6 are according to one embodiment of the present disclosure, and some configurations may be omitted or added as needed.

Additionally, a single picture may be encoded by being segmented into sub-pictures, slices, tiles, and the like. A sub-picture may include one or more slices or tiles. When a single picture is encoded by being segmented into multiple slices or tiles, all slices or tiles within the picture must be decoded prior to being displayed on the screen.

When a single picture is encoded into multiple sub-pictures, only an arbitrary sub-picture may be decoded and displayed on the screen. A slice may include multiple tiles or sub-pictures, and a tile may include multiple sub-pictures or slices.

Sub-pictures, slices, and tiles may be encoded or decoded independently of one another so as to be effective in improving parallel processing and processing speed, but a number of bits may increase because the encoded information of other adjacent sub-pictures, other slices, and other tiles cannot be used.

Furthermore, sub-pictures, slices, and tiles may be encoded by being segmented into multiple coding tree units (CTUs).

The coding tree unit may consist of a luma coding tree block (CTB) having a size of 128×128 and two chroma coding tree blocks having a size of 64×64.

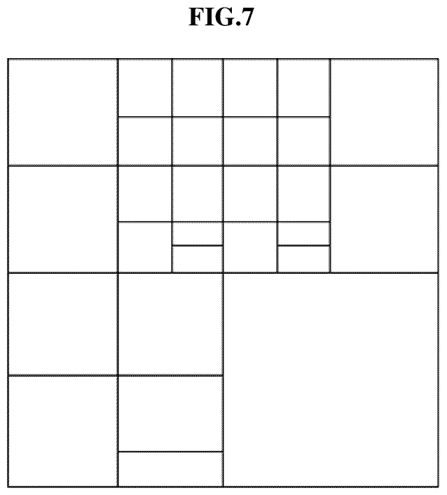

A single coding tree unit may constitute a single coding unit (CU) itself without being segmented, or may be segmented into multiple coding units as shown in FIG. 7. A coding unit may consist of a luma coding block (CB) and two chroma coding blocks.

A single coding unit may consist of one transform unit (TU), or may be segmented into multiple transform units. The transform unit may consist of a luma transform block (TB) and two chroma transform blocks.

Here, the coding unit represents a basic unit for processing a picture in the process of prediction, transform, quantization, entropy coding, and decoding, and a size and shape of a coding unit within a picture may not be constant.

The coding unit may have a square or non-square shape, and a non-square coding unit may include a vertical coding unit having a height greater than a width and a horizontal coding unit having a width greater than a height.

The coding tree unit is first segmented into a quad tree (QT) structure, so that one node with a size of 2N×2N may be segmented into four nodes with a size of N×N. Meanwhile, quad tree segmentation may be performed recursively, and not all nodes need to be segmented to the same depth.

The leaf nodes of a quad tree may be further segmented into a multi-type tree (MTT) structure. For example, in a multi-type tree structure, a single node may be segmented into a binary or ternary tree structure with horizontal or vertical segmentation. Accordingly, there may be four segmentation structures in a multi-type tree structure, such as vertical binary segmentation, horizontal binary segmentation, vertical ternary segmentation, and horizontal ternary segmentation.

In each tree structure, both the width and height of a node may both have values that are power of 2. For example, in a binary tree (BT) structure, a node having a size of 2N×2N may be segmented into two N×2N nodes by vertical binary segmentation, and into two 2N×N nodes by horizontal binary segmentation.

In addition, in a ternary tree (TT) structure, a node having a size of 2N×2N may be segmented into nodes having sizes of (N/2)×2N, N×2N, and (N/2)×2N by vertical ternary segmentation, and segmented into nodes having sizes of 2N×(N/2), 2N×N, and 2N×(N/2) by horizontal ternary segmentation. Such multi-type tree segmentation may be performed recursively.

A leaf node of a multi-type tree may be a coding unit, and when the coding unit is not larger than a maximum transform length, the corresponding coding unit may be used as a unit of prediction and transform without further segmentation. Meanwhile, when a width or height of a coding unit is greater than the maximum transform length, the corresponding coding unit may be segmented into a plurality of transform units without explicit signaling regarding segmentation.

The foregoing tree segmentation structure may have the same shape (single tree) for the luma block and the chroma block, or different shapes (dual trees) for the luma block and the chroma block.

Meanwhile, the foregoing block segmentation from a coding tree unit (CTU) to a coding unit (CU) may be performed through a rate-distortion optimization (RDO) process to select a segmentation structure with a smallest rate-distortion cost (RD cost) value within allowable size and depth conditions so as to determine a final coding unit.

The rate-distortion cost (RD cost) is a cost value calculated by considering the compression efficiency (rate) and image quality degradation (distortion) when a specific coding mode is applied to a block, and in order to calculate the cost, compression rate and image quality distortion values must be acquired through an abbreviated encoding procedure to which a specific coding mode is applied, which may be a cause of significantly increasing the complexity of the encoder.

For example, when a size of the CTU is 128×128, the encoder may calculate n RD costs while performing an abbreviated encoding process for each of multiple (n) coding modes for a 128×128 block, and set an coding mode corresponding to the smallest value among the n RD costs to a temporary coding mode of the 128×128 block.

Hereinafter, for convenience of explanation, it is assumed that a size of the CTU size is 64×64, but the size of the CTU may be a value larger than 64×64, for example, 128×128.

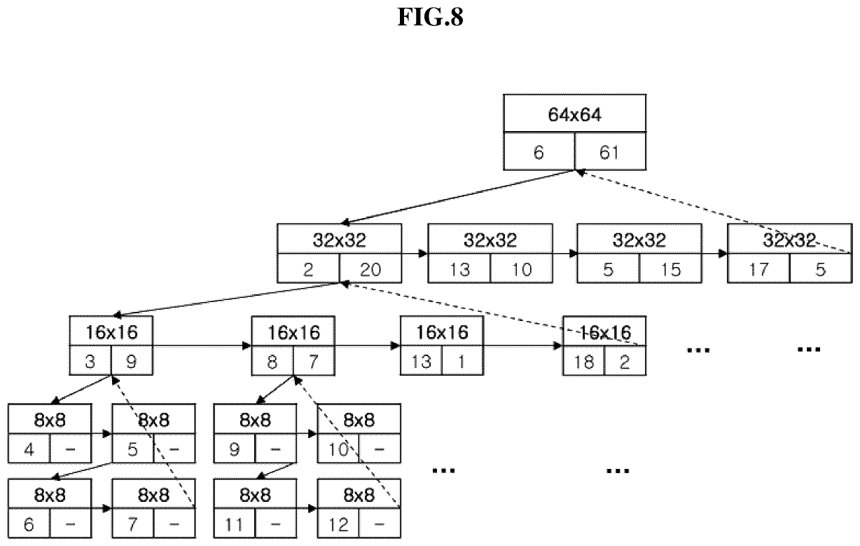

Referring to FIG. 8, an coding mode for a 64×64 block is “6”, and an RD cost thereof is set to “61”. Then, the 64x64 block is segmented into four 32×32 blocks, and for each 32×32 block, n RD costs are calculated for respective n coding modes, and then temporary coding modes are set for the respective 32×32 blocks.

An coding mode of a first 32×32 block is “2” and an RD cost thereof is “20”, an coding mode of a second 32×32 block is “13” and an RD cost thereof is “10”, an coding mode of a third 32×32 block is “5” and an RD cost thereof is “15”, and an coding mode of a fourth 32×32 block is “17” and an RD cost thereof is “15”.

In this case, a sum of the RD costs for four 32×32 blocks is compared with an RD cost value of the 64×64 block, and when the RD cost value of the 64×64 block is greater than the sum of the RD costs of the 32×32 blocks, segmentation into 32×32 blocks may be determined, and when the RD cost value of the 64×64 block is less than the sum of the RD costs of the 32×32 blocks, the 64×64 block may be used as a final CU without block segmentation.

In the case shown in FIG. 8, since the sum of the RD costs of four 32×32 blocks, “50”, is less than the RD cost of the 64×64 block, “61”, segmentation into 32×32 blocks may be determined.

Next, the 32×32 block may be segmented again into four 16×16 blocks, n RD costs for respective n coding modes may be calculated for each 16×16 block, then temporary coding modes may be set for the respective 16×16 blocks, and whether to segment into 16×16 blocks may be determined based on a result of comparing the RD costs of the 32×32 block and the 16×16 blocks.

In order to determine a final coding unit (CU), the foregoing process is repeated recursively.

As described above, a final coding unit may be determined while determinations on whether to segment a block and an coding mode are linked to each other, and this process may greatly increase the complexity of the encoder.

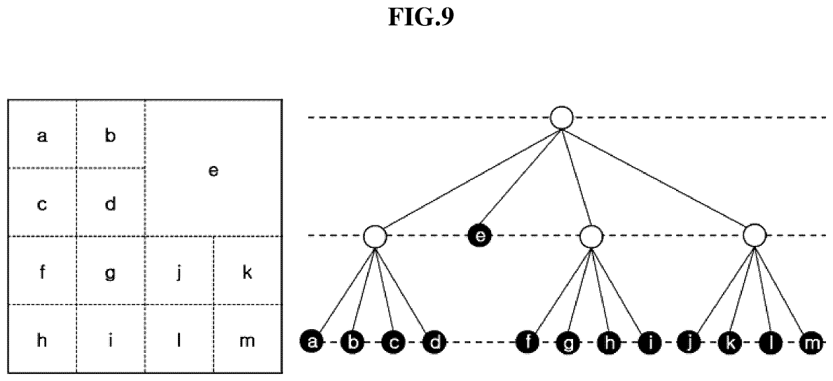

Referring to an example for a final block segmentation result shown in FIG. 9, for a coding tree unit (CTU) having a size of 64×64, a sum of the RD costs of four 32×32 blocks is smaller than the RD cost of the coding tree unit, and among them, the block “e” has an RD cost smaller than the sum of the RD costs of the four 16×16 blocks to be segmented, so it is determined as a final coding unit having a size of 32×32, and the remaining blocks are determined as final coding units having a size of 32×32.

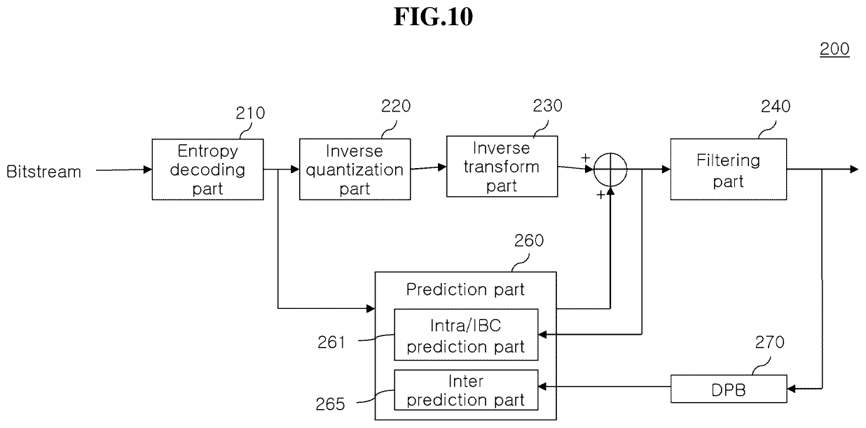

FIG. 10 is a diagram for explaining a configuration and operation of a video decoder for decoding a video, and the shown video decoder 200 may be configured to include an entropy decoding part 210, an inverse quantization part 220, an inverse transform part 230, a filtering part 240, a prediction part 260, and a decoded picture buffer (DPB) 270.

Referring to FIG. 10, the entropy decoding part 210 entropy decodes a bitstream to extract transform coefficient information, intra coding information, inter coding information, and the like for each area.

For example, the entropy decoding part 210 may acquire a binary code for transform coefficient information of a specific area from a bitstream, and may acquire a quantized transform coefficient by inverse binarizing the binary code.

The inverse quantization part 220 inverse quantizes the quantized transform coefficient, and the inverse transform part 230 restores a residual value using the inverse quantized transform coefficient.

Meanwhile, the residual value acquired from the inverse transform part 230 is added to a prediction value acquired from the prediction part 260 to restore the original pixel value.

The filtering part 240 performs a filtering operation using a deblocking filter, a sample adaptive offset, an adaptive loop filter, and the like to improve an image quality of the restored picture, and the filtered picture may be output or stored in the DPB 270 to be used as a reference picture for a next picture.

The prediction part 260 includes an intra/IBC prediction part 261 and an inter prediction part 265, and generates a prediction picture by utilizing an coding type decoded through the entropy decoding part 210, a transform coefficient for each area, intra/inter coding information, and the like.

In order to restore a current block for which decoding is performed, the decoded area of a current picture including the current block or other pictures may be used. A picture (or tile/slice) that performs intra prediction or intra BC prediction using only the current picture for restoration is called an intra picture or I picture (or tile/slice), and a picture (or tile/slice) that can perform all of intra prediction, inter prediction, and intra BC prediction is called an inter picture (or tile/slice).

Meanwhile, a picture (or tile/slice) that uses at most one motion vector and reference picture index to predict sample values of each block among inter-pictures (or tiles/slices) is called a predictive picture or P picture (or tile/slice), and a picture (or tile/slice) that uses at most two motion vectors and reference picture indices is called a bi-predictive picture or B picture (or tile/slice).

That is, a P picture (or tile/slice) uses at most one set of motion information to predict each block, and a B picture (or tile/slice) uses at most two sets of motion information to predict each block. Here, the motion information set may include one or more motion vectors and one reference picture index.

The intra/IBC prediction part 261 may generate a prediction block using intra coding information and restored samples within the current picture, and the intra coding information may include at least one of an intra prediction mode, a most probable mode (MPM) flag, and an MPM index.

The intra/IBC prediction part 261 may predict sample values of the current block using restored samples located on a left and/or top of the current block as reference samples.

For example, the reference samples may be samples adjacent to a left boundary of the current block and/or samples adjacent to a top boundary thereof, and may be samples located on a line within a preset distance from the left boundary of the current block and/or samples located on a line within a preset distance from the top boundary of the current block among samples neighboring blocks of the current block. In this case, the neighboring blocks of the current block may include at least one of a left (L) block, an above (A) block, a below-left (BL) block, an above-right (AR) block, or an above-left (AL) block adjacent to the current block.

Additionally, the intra/IBC prediction part 261 may restore a current area by referring to a specific area including restored samples within the current picture. To this end, the intra/IBC prediction part 261 may perform IBC prediction using IBC coding information acquired from the entropy decoding part 210, and the IBC coding information may include block vector information.

The inter prediction part 265 may generate a prediction block using a reference picture and inter coding information stored in the DPB 270, and the inter coding information may include a set of motion information (reference picture index, motion vector information, etc.) of the current block for the reference block.

Meanwhile, inter prediction may include L0 prediction, L1 prediction, and bi-prediction.

The L0 prediction is a prediction using one reference picture included in an L0 picture list, and the L1 prediction is a prediction using one reference picture included in an L1 picture list. To this end, one set of motion information (e.g., motion vectors and reference picture indices) may be required.

In a bi-prediction method, at most two reference areas may be used, and the two reference areas may exist in the same reference picture or may exist in different pictures. Accordingly, in at most two sets of motion information used in the bi-prediction method, two motion vectors may correspond to the same reference picture index or may correspond to different reference picture indices.

In this case, the reference pictures, which are pictures located temporally before or after the current picture, may be completed pictures that have already been restored, and the two reference areas used in the bi-prediction method may be areas selected from the L0 picture list and the L1 picture list, respectively.

The inter prediction part 265 may acquire a reference block of the current block using a motion vector and a reference picture index, and the reference block exists within a reference picture corresponding to the reference picture index.

Additionally, a sample value of a block specified by a motion vector or its interpolated value may be used as a predictor of the current block. For motion prediction with pixel accuracy in subpel units, an 8-tap interpolation filter may be used for a luma signal and a 4-tap interpolation filter may be used for a chroma signal.

Meanwhile, the configuration and operation of the decoder described with reference to FIG. 10 are according to one embodiment of the present disclosure, and some configurations may be omitted or added as needed, and the decoder may decode a video by performing a reverse process of the foregoing encoding method of the encoder.

As described above, a game video generated from the game server 10 is computer graphics processed data, and there is a difference in the change in pixel value compared to a live-action video captured by a camera.

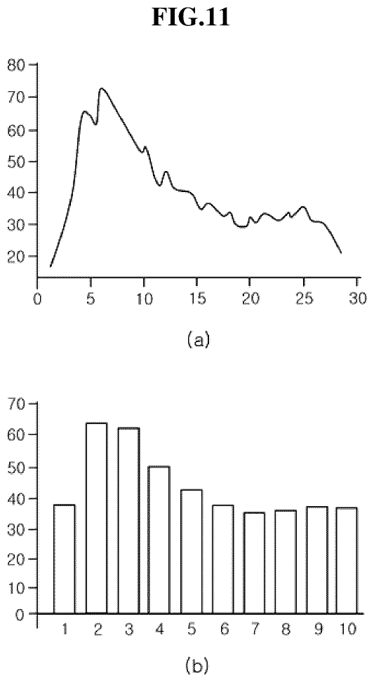

A graph shown in (a) of FIG. 11 shows a pixel value distribution chart for a live-action video, in which the pixel values have a continuous form like an analog signal. In contrast, a graph shown in (b) of FIG. 11 shows a pixel value distribution chart for the game video, in which it can be seen that the pixel value distribution chart of the graphically processed game video has a characteristic of being concentrated on a few sample pixel values, like a digital signal.

This means that while the pixel values of a live-action video with added noise naturally have various values, in the case of a randomly produced game video, the distribution chart shows a simple shape as the values are biased toward specific pixel values.

More specifically, in the case of a live-action video captured by a camera, noise may occur due to a loss of charge or an increase in dark current caused by heat generation of a sensor during a process of changing an amount of charge corresponding to a brightness of light into an analog electrical signal through a CCD or CMOS image sensor and then transforming it into a digital signal. In addition, even a subtle change in light intensity or a slight change in air flow may cause a difference in the pixel values of an image.

Accordingly, in the case of a live-action video, the probability that pixel values at the same location in two consecutive images on the time axis, for example, a pixel value at location (10,10) in a t-th image and a pixel value at location (10,10) in a (t+1)-th image, are the same may be very low.

In contrast, in the case of a game video generated through computer graphics processing, when an object in the image has not moved, the probability that pixel values at the same location in two consecutive images on the time axis, for example, pixel values corresponding to the corresponding object location in a t-th image and pixel values corresponding to the corresponding object location in a (t+1)-th image, are the same may be very high.

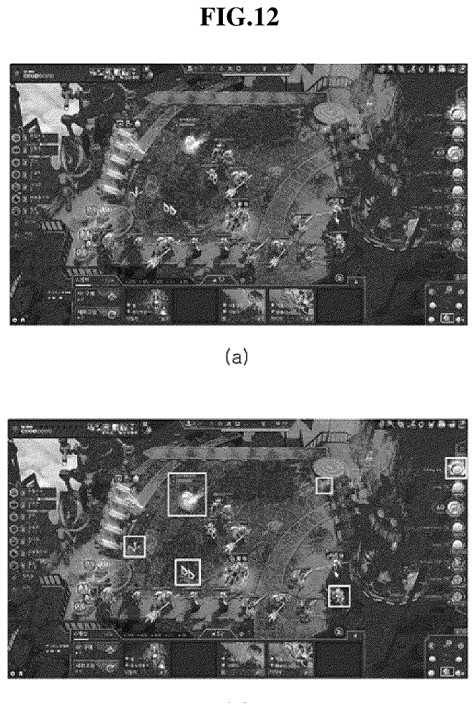

FIG. 12 is drawings for explaining the characteristics according to a motion of an object in a game video, in which (a) and (b) of FIG. 12 show a t-th image and a (t+1)-th image, respectively, which are consecutive on the time axis in the game video.

Referring to FIG. 12, the pixel values of a t-th image shown in (a) of FIG. 12 and a (t+1)-th image shown in (b) of FIG. 12 are very likely to be different only in areas where there is a motion of an object indicated by a square box, and the same in the remaining areas in (b) of FIG. 12.

Meanwhile, when the game server 10 receives a user action event, renders a game screen, visualizes the corresponding screen, and transmits it to the media server 20, the media server 20 then compresses and streams a video received from the game server 10.

In this case, the game server 10 may know information on an object moving within the corresponding screen during a process of rendering the game screen and visualizing the screen. For example, the game server 10 may have information on areas where there is a motion of an object indicated by a square box in an image as shown in (b) of FIG. 12.

This is because the game video is rendered through the game engine to allow the game server 10 to acquire information on a screen configuration in real time for each frame, and through this, the game server 10 may acquire location information or background change information of an object moving in a specific frame, and furthermore, information on an area where a change in pixel value occurs in the corresponding frame.

According to another embodiment of the present disclosure, when encoding a video generated by graphic processing, such as a game video, object location information or background transition information provided from a game server may be applied to an encoding process, such as block segmentation or coding mode determination, thereby reducing the operational complexity of the encoder.

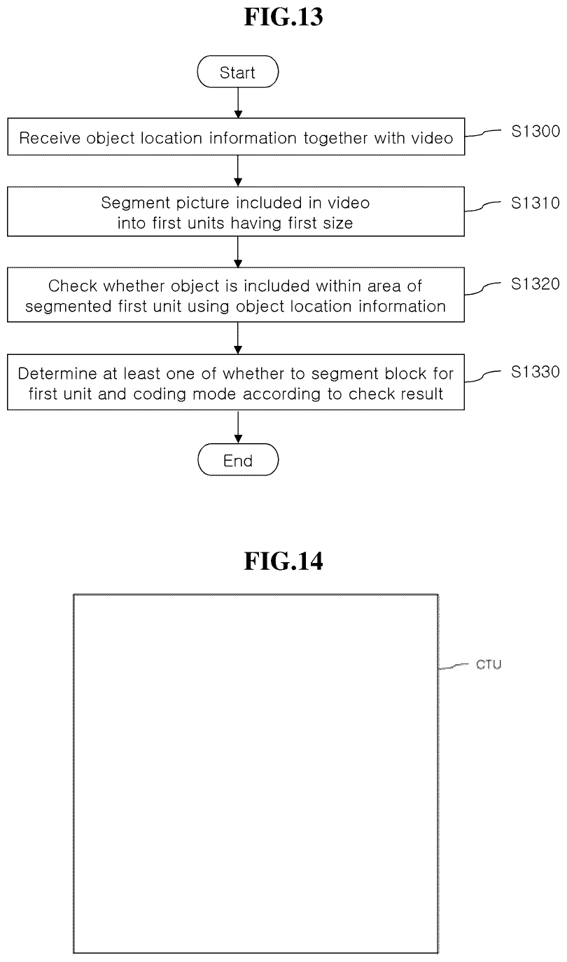

FIG. 13 is a flowchart showing a video encoding method according to another embodiment of the present disclosure, and hereinafter, the method will be described as being performed by a video encoder included in the media server 20, but the present disclosure is not limited thereto.

Referring to FIG. 13, when object location information is received from the game server 10 together with a game video (step S1300), the encoder segments a picture included in the video to be encoded into first units having a first size (step S1310).

For example, the first unit may be the foregoing coding tree unit (CTU), and the first size may be 128×128, but the present disclosure is not limited thereto, and the first size may be included in a bitstream as header information to be transmitted to the decoder.

The encoder checks whether an object is included within an area of the first unit segmented in step S1310 using the object location information received in step S1300 (step S1320).

In step S1320, the encoder may check whether there is a moving object or a newly appeared new object within the area of the first unit based on the object location information received from the game server 10.

Then, based on the check result, the encoder determines at least one of whether to segment a block for the first unit and an coding mode (step S1330).

As a first embodiment for a method of determining whether to segment a block and an coding mode in step S1330, the encoder may configure the first unit as one coding unit (CU) if no object is included in the area of the first unit, and determine an inter prediction mode for the first unit as a skip mode.

As described above, a coding tree unit (CTU) may be segmented into multiple coding units (CUs), and information on a minimum size (min CU) of the coding unit (CU) may be included in a bitstream as header information to be transmitted to the decoder.

Meanwhile, for inter prediction, any one of a skip mode, a merge mode, and a motion vector prediction (MVP) mode may be applied to derive a prediction sample for a current block.

In the skip mode and the merge mode, motion information of a neighboring block may be used as motion information of the current block, and in the case of the skip mode, unlike the merge mode, a residual value, which is a difference between the prediction sample and the original sample, is not transmitted.

In the MVP mode, a motion vector of the neighboring block is used as a motion vector predictor to transmit an MVD value, which is a difference value between a motion vector prediction value obtained from the neighboring block and a final motion vector value.

Meanwhile, when an object is included within the area of the first unit, the encoder may determine at least one of whether to segment a block for the first unit and an coding mode based on a rate-distortion cost (RD cost) through the foregoing rate-distortion optimization (RDO) process.

FIG. 14 shows a coding tree unit (CTU), and hereinafter, an example is given of a CTU size of 64×64, but the CTU size may be a value larger than 64×64, for example, 128×128.

When it is determined that no moving object with motion is included in an area corresponding to a coding tree unit (CTU) based on object location information received from the game server 10, block segmentation process and coding mode determination for the corresponding coding tree unit (CTU) may be skipped, the coding tree unit (CTU) may be set to a final coding unit (CU), and the coding mode may be determined as a skip mode.

Meanwhile, as shown in FIG. 15, when a moving object Ob with motion is included within an area corresponding to a coding tree unit (CTU), block segmentation and coding mode may be determined through an RDO process for the corresponding coding tree unit (CTU).

As another example, when an object is included within an area of a first unit, an encoder may segment the first unit into second units having a second size smaller than the first size, and check whether an object is included within an area of the segmented second unit using object location information received from the game server 10.

In this case, when an object is not included in the area of the second unit, the encoder may determine the second unit as one coding unit and determine an inter prediction mode for the second unit as a merge skip mode.

Meanwhile, when an object is included in the area of the second unit, the encoder may segment the second unit into third units having a third size smaller than the second size, and check again whether an object is included in the area of the segmented third unit using the object location information received from the game server 10.

In this case, when an object is not included in the area of the third unit, the encoder may determine the third unit as one coding unit, and determine an inter prediction mode for the third unit as a merge skip mode.

Meanwhile, the foregoing process may be repeated until the first unit is segmented into units having a specific size, and when an object is included within an area of the unit having the specific size, the encoder may determine at least one of whether to segment the corresponding unit into blocks and an coding mode based on a rate-distortion cost (RD cost).

Here, the specific size into which the first unit, the coding tree unit (CTU), can be segmented may be a size corresponding to a preset specific depth, or may be a minimum size (min CU) that the coding unit (CU) can have.

As a second embodiment for a method of determining whether to segment a block and an coding mode in step S1330, the encoder may check whether a moving object with motion is included in the corresponding area up to a block level segmented at a specific depth from a coding tree unit (CTU), set, when no object is included, the corresponding area to a final coding unit (CU), and set the coding mode to a skip mode.

In this case, when an object is included in the corresponding area, the encoder may check the object again by performing block segmentation once more if the corresponding area is larger than a block segmented into a specific depth, and determine block segmentation and coding mode based on a rate-distortion cost (RD cost) if the corresponding area is the same size as the block segmented into the specific depth.

As shown in FIG. 15, when a moving object Ob with motion is included within an area corresponding to a coding tree unit (CTU), the encoder may segment the coding tree unit (CTU) into four 32×32 areas without determining an coding mode for the corresponding coding tree unit (CTU).

Next, the encoder may check whether each of the four 32×32 areas includes a moving object with motion, skip block segmentation process and coding mode determination for the 32×32 area that does not include the object, set the corresponding 32×32 area to a final coding unit (CU), and determine the coding mode to a skip mode.

Meanwhile, when the foregoing specific depth is set to a 32×32 block size, for the 32×32 area including the object, block segmentation and coding mode may be determined based on a rate-distortion cost (RD cost).

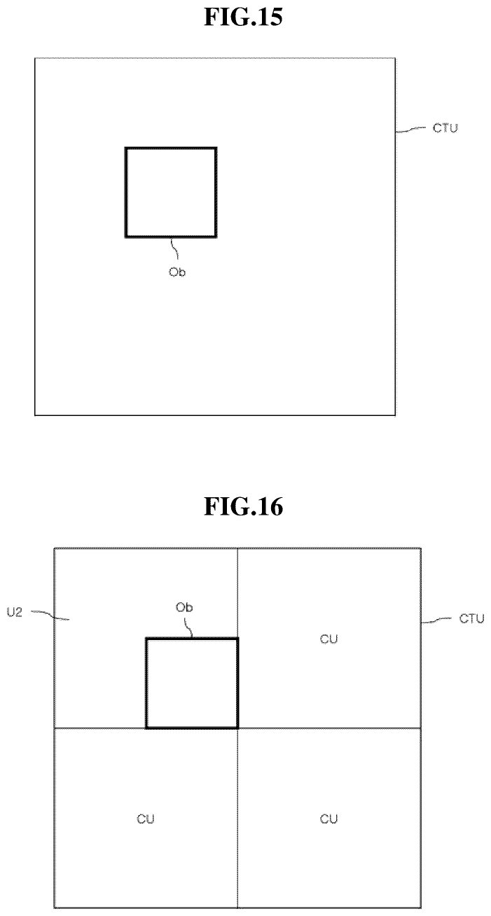

As shown in FIG. 16, among the four 32×32 areas into which the coding tree unit (CTU) is segmented, block segmentation and coding mode may be determined based on a rate-distortion cost (RD cost) for an area U2 including an Object Ob, and the remaining three 32×32 areas that do not include the Object Ob may be all set to a final coding unit (CU), and the coding mode may be determined as a skip mode.

As a third embodiment for a method of determining whether to segment a block and an coding mode in step S1330, the encoder may check whether a moving object with motion is included in the corresponding area up to a block level of a minimum size (min CU) that a coding block (CU) can have from a coding tree unit (CTU), set, when no object is included, the corresponding area to a final coding unit (CU), and set the coding mode to a skip mode.

In this case, when an object is included in the corresponding area, the encoder may check the object again by performing block segmentation once more if the corresponding area is larger than a minimum size (min CU), and determine block segmentation and coding mode based on a rate-distortion cost (RD cost) if the corresponding area is the same as the minimum size (min CU).

As shown in FIG. 16, when a moving object Ob with motion is included within an area U2 having a size of 32×32, the encoder may segment the corresponding area U2 into four 16×16 areas.

Next, the encoder may check whether each of the four 16×16 areas includes a moving object with motion, skip block segmentation process and coding mode determination for the 16×16 area that does not include the object, set the corresponding 16×16 area to a final coding unit (CU), and determine the coding mode to a skip mode.

Meanwhile, when the foregoing minimum size (min CU) is a 16×16 block size, block segmentation and coding mode may be determined based on a rate-distortion cost (RD cost) for the 16×16 area including the object.

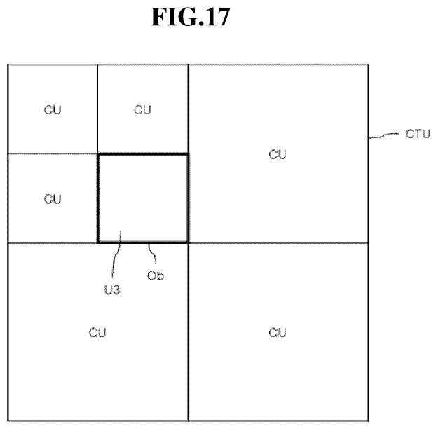

As shown in FIG. 17, block segmentation and coding mode may be determined based on a rate-distortion cost (RD cost) for an area U3 including an object Ob among four 16×16 areas, and the remaining three 16×16 areas that do not include the object Ob may all be set to final coding units (CUs), and the coding mode may be determined as a skip mode.

In the above, the minimum size (min CU) that a coding block (CU) can have has been described as a 16×16 block size, but the present disclosure is not limited thereto, and may have a smaller size, for example, a 4×4 block size.

According to still another embodiment of the present disclosure, the encoder may additionally receive background change information from the game server 10, and determine to allow intra prediction to be used for a picture recognized as a scene change according to the background change information received from the game server 10.

For example, when it is determined that a scene has changed in a particular frame using background change information, the encoder may encode the corresponding frame as an intra frame regardless of an intra period or a size of group of pictures.

According to yet still another embodiment of the present disclosure, when it is determined that a new object is included within an area of a first unit based on object location information received from the game server 10, an coding mode for at least one coding unit (CU) belonging to the first unit may be determined as an intra prediction mode.

For example, the encoder may use inter prediction to encode a coding block (CU) determined to include a newly appeared new object using object location information in an inter frame.

Meanwhile, the foregoing object location information and background change information may be in the form of a vector or matrix. Additionally, matrix information may further include information related to scaling, rotation, and the like, in addition to information related to translation.

Furthermore, a game engine may express a change in object or background, which is a game character in the 3D domain, in the form of a matrix, but the corresponding 3D information may be changed to 2D information in the image domain for a video encoding process.

The foregoing methods in this specification may be performed through a processor in a video encoder or a video decoder. Additionally, the encoder may generate a bitstream that is decoded by a video signal processing method, and the bitstream generated by the encoder may be stored in a computer-readable non-transitory storage medium (recording medium).

The foregoing embodiments of the present disclosure may be implemented through various means. For example, embodiments of the present disclosure may be implemented by hardware, firmware, software, or a combination thereof.

Some embodiments may also be implemented in the form of a recording medium including instructions executable by a computer such as a program module executed by the computer. A computer-readable medium may be any available medium that can be accessed by a computer, and includes both volatile and non-volatile media, and removable and non-removable media.

Furthermore, the computer-readable medium may include both a computer storage medium and a communication medium. The computer storage medium includes both volatile and nonvolatile, removable and non-removable media implemented in any method or technology for storing information such as computer-readable instructions, data structures, program modules or other data. The communication medium typically includes computer-readable instructions, data structures or other data in a modulated data signal such as program modules, or other transport mechanisms, and includes any information delivery medium.

In addition, while the preferred embodiments of the present disclosure have been shown and described above, it will be of course understood by those skilled in the art that various modifications may be made without departing from the gist of the disclosure as defined in the following claims, and it is to be noted that those modifications should not be understood individually from the technical concept and prospect of the present disclosure.

1. A method of encoding a video, the method comprising:
receiving a video in an RGB format;
transforming the received RGB format video into a video in an YCbCr format;
encoding the transformed YCbCr format video; and
transmitting transform information used to transform the RGB format video into the YCbCr format video together with the encoded YCbCr format video.

2. The method of claim 1, wherein the transform information comprises:
color specification information indicating a color space that can be expressed by the RGB format.

3. The method of claim 1, wherein the transform information comprises:
color transformation information indicating a transform method used for color transformation from the RGB format to the YCbCr format.

4. The method of claim 1, wherein the transforming comprises:
performing an optical-electro transform on the RGB format video, and
wherein transfer function information indicating a transfer function used in the optical-electrical transform is included in the transform information.

5. The method of claim 1, wherein the transforming comprises:
performing quantization on the transformed YCbCr format video; and
performing chroma down-sampling on the quantized YCbCr format video.

6. The method of claim 1, wherein the transmitting transmits a bitstream in which at least one of the transform information and the camera viewpoint information is included in a high-level syntax (HLS) together with information on the encoded YCbCr format video, and
wherein at least one of the transform information and the camera viewpoint information is inserted into at least one of video usability information (VUI), supplemental enhancement information (SEI), a video parameter set (VPS), a sequence parameter set (SPS), a picture parameter set (PPS), and a picture header (PH).

7. The method of claim 1, wherein the encoding comprises:
receiving object location information;
segmenting a picture included in a video to be encoded into first units having a first size;
checking whether an object is included within an area of the segmented first unit using the received object location information; and
determining at least one of whether to segment a block for the first unit and an coding mode according to the check result.

8. The method of claim 7, wherein the determining comprises:
determining, when an object is not included within the area of the first unit, the first unit as one coding unit, and determining an inter prediction mode for the first unit as a skip mode.

9. The method of claim 7, wherein the determining comprises:
determining, when an object is included within the area of the first unit, at least one of whether to segment a block for the first unit and an coding mode based on a rate-distortion cost.

10. The method of claim 7, wherein the determining comprises:
segmenting, when an object is included within the area of the first unit, the first unit into second units having a second size smaller than the first size; and
checking whether an object is included within the area of the segmented second unit using the received object location information; and
determining, when an object is not included within the area of the second unit, the second unit as one coding unit, and determining an inter prediction mode for the second unit as a skip mode.

11. The method of claim 10, wherein the determining comprises:
segmenting, when an object is included within the area of the second unit, the second unit into second units having a third size smaller than the second size; and
checking whether an object is included within the area of the segmented third unit using the received object location information; and
determining, when an object is not included within the area of the third unit, the third unit as one coding unit, and determining an inter prediction mode for the third unit as a skip mode.

12. The method of claim 7, wherein the first unit is segmented into units having a specific size, and
wherein when an object is included within an area of the unit having the specific size, at least one of whether to segment a block for the unit having the specific size and an coding mode is determined based on a rate-distortion cost (RD cost).

13. The method of claim 12, wherein the specific size is a minimum size that the coding unit can have.

14. The method of claim 7, further comprising:
receiving background change information,
wherein intra prediction is used for a picture recognized as a scene change according to the received background change information.

15. The method of claim 7, wherein, when it is determined that a new object is included within the area of the first unit according to the received object location information, the coding mode for at least one coding unit belonging to the first unit is determined to be an intra prediction mode.

16. A video encoding device performing the method of claim 1.

17. A method of decoding a video, the method comprising:
receiving a bitstream comprising information on a video in an encoded YCbCr format, and transform information used to transform a video in an RGB format into the YCbCr format video;
decoding the encoded YCbCr format video; and
transforming the decoded YCbCr format video into an RGB format video using the transform information.

18. The method of claim 17, wherein the transform information comprises:
at least one of color specification information indicating a color space that can be expressed by the RGB format, color transformation information indicating a transform method used for color transformation from the RGB format to the YCbCr format, and transfer function information indicating a transfer function used for an optical-electrical transform for the RGB format video.

19. The method of claim 17, wherein the transforming is performed by linking the transform information and bit-depth information per pixel, and
wherein the transforming comprises:
performing chroma up-sampling on the decoded YCbCr format video;
performing inverse quantization on the YCbCr format video on which the chroma up-sampling has been performed;
transforming the video on which the inverse quantization has been performed into an RGB format; and
performing an electro-optical transform on the video transformed into the RGB format.

20. A video decoding device performing the method of claim 17.
